(19) United States
(12) Patent Application Publication
(10) Pub. No.: US 2003/0018523 A1
(43) Pub. Date: Jan. 23, 2003

(54) Rewards program using electronically encoded instruments

(76) Inventors: Ethan Rappaport, Orange, CT (US); Arthur Swanberg, Westport, CT (US)

Correspondence Address: Drinker Biddle & Reath, LLP, One Logan Square, 18th and Cherry Sts., Philadelphia, PA, 19103-6996, US

(21) Appl. No.: 09/910,376

(22) Filed: Jul. 20, 2001

(51) Int. Cl. G06F 17/60

(52) U.S. Cl. 705/14; 705/17

(57) ABSTRACT

The invention is a method and system that allows a customer to receive rewards. The rewards will typically be in the form of coupons, points, or access to restricted material, such as a restricted web page, a restricted game, or a consumer good that is inoperable until it is rendered operable by the reward. The rewards are saved in electronic form on an instrument, such as a smart card or other medium capable of storing electronic data. The rewards can be earned based on the customer's purchases. The method includes: providing a customer with an instrument capable of storing data in electronic form for later retrieval; reading and updating data stored on the instrument, the data being available when the customer presents the instrument at a retail location, and the data creates a record of the customer's purchasing activity; determining, from the record of the customer's purchasing activity, whether the customer meets at least one preselected criterion for a reward; and enabling the customer to use the instrument to obtain a reward based on the customer's purchasing activity. The instrument can store electronic data that represents coupons or accumulated points, either of which the customer can redeem for value at a retailer or retailer's web site. The instrument may be a smart card or any three dimensional object. An optional central storage system may be provided that stores reward data that may be used to generate coupons, points exchangeable for access to restricted material, or access to restricted material.

### FIELD OF THE INVENTION

This invention pertains to a rewards program that rewards customers based on their purchasing activity.

### BACKGROUND OF THE INVENTION

Rewards programs for customers take many forms. The most common rewards for customers come in the form of coupons. Coupons are often given based on a consumer's past purchases. Other rewards include special discounts for customers who purchase frequently (for example, if a customer purchases twelve pounds of coffee, the thirteenth pound is free), or make large purchases (if a customer buys $1,000 worth of merchandise, the customer will receive 10% off on the next purchase).

It is becoming increasingly common for coupons to be printed for a customer at the point of purchase, as he pays for his purchases at the store. For example, after buying product Brand X, a customer may be given a discount coupon for Brand X, redeemable on a subsequent purchase.

Rewards programs where a customer gets a “shopper club card” from the store where the customer makes purchases are also common. Upon presentation of the card at the point of sale, the customer receives certain discounts based on the customer's purchasing activity.

### SUMMARY OF THE INVENTION

In its broadest aspects, the invention is a method that allows a customer to receive rewards if the customer meets a preselected criterion. The rewards can be in any form, although the rewards will typically be in the form of coupons, points, or access to restricted material, such as a restricted web page, a restricted game, or a consumer good that is inoperable until it is rendered operable as the reward. The rewards are saved in electronic form on an instrument, such as a smart card (or chip card, these cards are capable of storing and transmitting data) or other medium capable of storing electronic data. The rewards can be earned based on the customer's purchases, or can be purchased or simply requested by the customer.

The invention also encompasses a method of monitoring purchasing activity of customers and rewarding customers who meet at least one preselected criterion. The method comprises providing a customer with an instrument capable of storing data in electronic form for later retrieval. The data are available when the customer presents the instrument at a retail location, and comprise a record of the customer's purchasing activity. The data are read and updated at the retail location, and the updated data are stored on the instrument. A determination is made, from the record of the customer's purchasing activity, whether the customer meets at least one preselected criterion for a reward. If so, the customer is enabled to use the instrument to obtain a reward based on the customer's purchasing activity.

The instrument can store electronic data that represents coupons or accumulated points, either of which the customer can redeem for value at a retailer or retailer's web site. The customer can also redeem the points or coupons for access to restricted material, such as a web site, or for consumer goods. The instrument may be a smart card (capable of storing and transmitting data) or any three dimensional object (such as a toy).

In another aspect, the invention is a system for rewarding a customer. The system comprises an instrument, an interface device for reading and writing data from and to the instrument, and a processor (often, but not exclusively, a personal computer). The instrument is usable by a customer and is capable of storing data in electronic form for later retrieval. The interface device reads data stored on the instrument and writes to the instrument data representing the reward. The processor determines whether to issue the reward to the customer based on the customer's purchase or purchasing history when a customer presents the instrument at a retail location when the customer makes a purchase. Available rewards are similar to those described above.

In another embodiment, the invention encompasses a method for storing changeable user data on an instrument. An instrument capable of storing and transmitting instrument data is issued to a user. Each time the instrument is used by the user, instrument data is read from the instrument, updated, and then updated data is written to and stored on the instrument. Instrument data read from the instrument is sent to a processor, which communicates with a device for reading data on the instrument and writing data to it. A central storage system is provided that stores reward data and instrument data, the reward data may be used to generate coupons, points exchangeable for access to restricted material, or access to restricted material. Finally, there is a communication link between the device and the central storage system capable of exchanging instrument data between the instrument and the central storage system, and also capable of exchanging reward data between the instrument and the central storage system. The user can selectively redeem the instrument data for a retail coupon.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown.

FIG. 1 is a flow chart showing steps of an exemplary method according to the invention.

FIG. 2 is a simplified schematic diagram one form of the system according to the invention.

FIG. 3 is a simplified schematic diagram an alternate form of the system according to the invention.

FIG. 4 is a simplified schematic diagram an alternate form of the system according to the invention, wherein the rewards are issued at the point of sale.

FIG. 5 is a simplified schematic diagram an alternate form of the system according to the invention, wherein the rewards are issued at the point of sale.

FIG. 6 is a view of a toy activated by the instrument of the current invention.

### DETAILED DESCRIPTION OF THE DRAWINGS

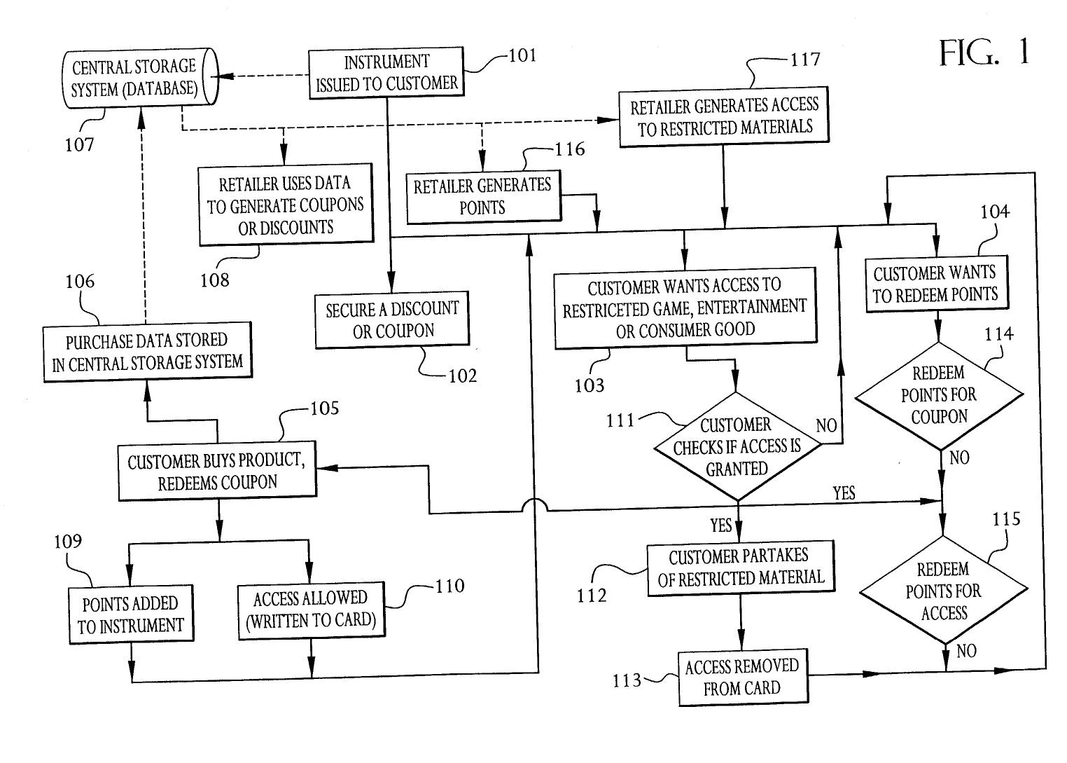

Referring now to the drawings, wherein like numerals indicate like elements, there is shown in a method for rewarding a customer, as shown in FIG. 1. FIG. 1 shows a flow chart showing the method of the current invention. First, a customer receives an instrument 101, for instance from a promotion run by a retailer that gives away its instruments. If the retailer gives away its instruments to new customers, it serves as an invitation to make purchases from the retailer that the customer may not have otherwise made. The customer may then purchase goods and/or services from the retailer. At any time, the customer may present the instrument to the retailer, but preferably does so each time he makes a purchase. Once the customer receives the instrument, he has three choices: secure a discount or coupon 102, access restricted material (game, entertainment, consumer good) using the instrument 103, or redeem the reward 104. At certain retailers, any or all of these three choices may be offered to the customer. Steps 106, 107, 108, 116, and 117 are related to an optional central storage system, and are shown enclosed in a dashed line to show their optional nature.

1. Securing a discount or coupon. If the customer chooses to secure a discount or coupon 102, the coupon is secured in several ways. The customer may get the discount or coupon by visiting the retailer (traditional or internet), the customer may be sent the coupon, or the customer may be given the coupon following a purchase. When the customer buys a product or service from a retailer, he may redeem the discount or coupon 105 (or a portion of the reward) for value against his purchase. The coupon is typically in the form of electronic data. The electronic data is transferred to the instrument, and stored thereon in electronic form. When the customer chooses to redeem the electronic coupon, she transfers the electronic data that represents the coupon to the retailer. The retailer redeems the electronic coupon data for value.

The retailer may at its option, operate a central storage system (or database) 107, in which case, the customer's purchase history is stored in the database 106, so the database 107 can generate reward data in the form of targeted discounts or coupons to the customer 108, allowing access to restricted material 117, or generating points to the smart card 116 (choices 116 and 117 lead to options 102, 103, or 104). All of these options encourage the customer to make purchases at the retailer and use the retailer's products, thus serving the purpose of growing the retailer's business. The customer's visit to the retailer may be stored on the database. The database could use this information to reward customers who are particularly loyal (as measured by visits to the retailer or retailer's website).

After the purchase, the retailer has the option of rewarding the customer with more rewards 109, or access to restricted material 110. Choices 109 and 110 give the customer options 102, 103, or 104.

2. Accessing restricted material. If the customer chooses to access restricted material 103, the computer checks if access is granted based on the rewards on the instrument 111. If access is not granted, the customer can still secure a discount or coupon 102, access different restricted material 103, or redeem his points 104. If the customer is granted access, he partakes of the restricted material (plays the game, views the material, or activates the consumer good) 112. Once the user partakes of the restricted material, the access is removed from the instrument 113, and the customer may again choose from options 102, 103, and 104.

3. Redeem points. If the customer has points on his instrument, he can choose to redeem those points 104 for a discount or coupon 114 or for access to restricted material 115. If the customer chooses to redeem the points for a discount or coupon 114, he can use those discounts or coupons 105 at a retailer. If the customer redeems the points for access to restricted material, the device will check to insure that access is granted 111. Following redemption of the points in either of these manners, the customer may choose from options 102, 103, or 104.

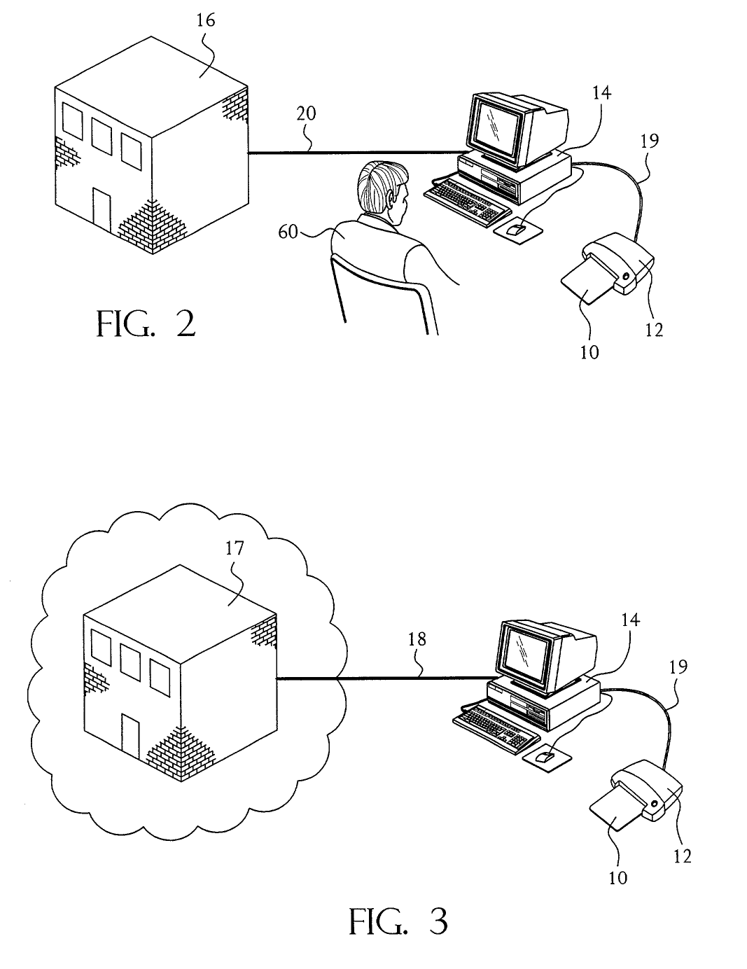

FIG. 2 shows a system of the invention in its presently preferred embodiment. The system comprises an instrument 10 capable of storing electronic data for later retrieval, a device 12, and a computer 14. The instrument 10 cooperates with a device 12 for reading data from and writing data to the instrument. The device 12 is connected to a personal computer 14 by means of communication link 19, which is, in turn, in communication with a retailer 16 via a communication link 20. FIG. 3 shows a similar arrangement where the computer 14 is connected to a retail web page 17 through the internet 18.

The instrument 10 could be a smart card (as shown in the FIGS. 2-5), a three dimensional object, a diskette, etc. If the instrument 10 is a smart card, device 12 is a reader/writer known in the art. To simplify the description that follows, it is assumed that instrument 10 is a smart card, but other instruments can be used.

The system works as follows: when a customer visits a retailer, she inserts her instrument 10 into the device 12. Assuming that the retailer is a traditional “brick and mortar” retailer, the device 12 and the computer 14 will be located at the retailer 16, and the smart card 10 will be inserted into the device 12 at the point of purchase (usually at the cash register).

Once the customer inserts her smart card 10 into the device 12, the computer 14 determines whether the customer is entitled to a reward based on her current purchases, or based on her past purchasing activity. The purchasing history, or user consumption data, of the customer is available to the retailer from the data stored on the smart card (or the card 10 may have a unique identifier for the customer that allows the computer to search a database for the customer's purchase history). If the customer has made a certain number of purchases from the retailer in the past (above a threshold amount), the customer is entitled to a reward that is then be written to the smart card 10 by the device 12. Other criteria include rewarding a customer based on her purchases that day. For example, if the customer purchased product X, she might be rewarded with a discount on product Y. The retailer could also reward the customer just for showing up, for being the tenth customer, or even reward the customer just for asking for one.

The retailer can also be an internet retailer 17, as illustrated in FIG. 3. In the case of an internet retailer 17, the customer can be in any location with internet access. The customer would have the computer 14 and device 12 at her disposal while visiting the retailer's website 17 over the internet 18. The computer 14 is in communication with the retailer website 17 via communication link 20, while the device 12 is in communication with the computer via the communication link 19. The customer makes a purchase at the web retailer 17, much like she would at a traditional store. Once the customer inserts her smart card 10 into the device 12, the retailer's computer, through its website 17, determines whether the customer is entitled to a reward based on preselected criteria. If the customer is entitled to a reward, that reward is written to the smart card 10 by the device 12. If the criterion is not met, the card is updated to reflect the customer's purchase.

This system benefits both the customer and the retailer. The benefit to the customer is that she gets a reward, and the benefit to the retailer is that it encourages more purchases by the customer. More importantly, the retailer encourages the customer to make more purchases from itself.

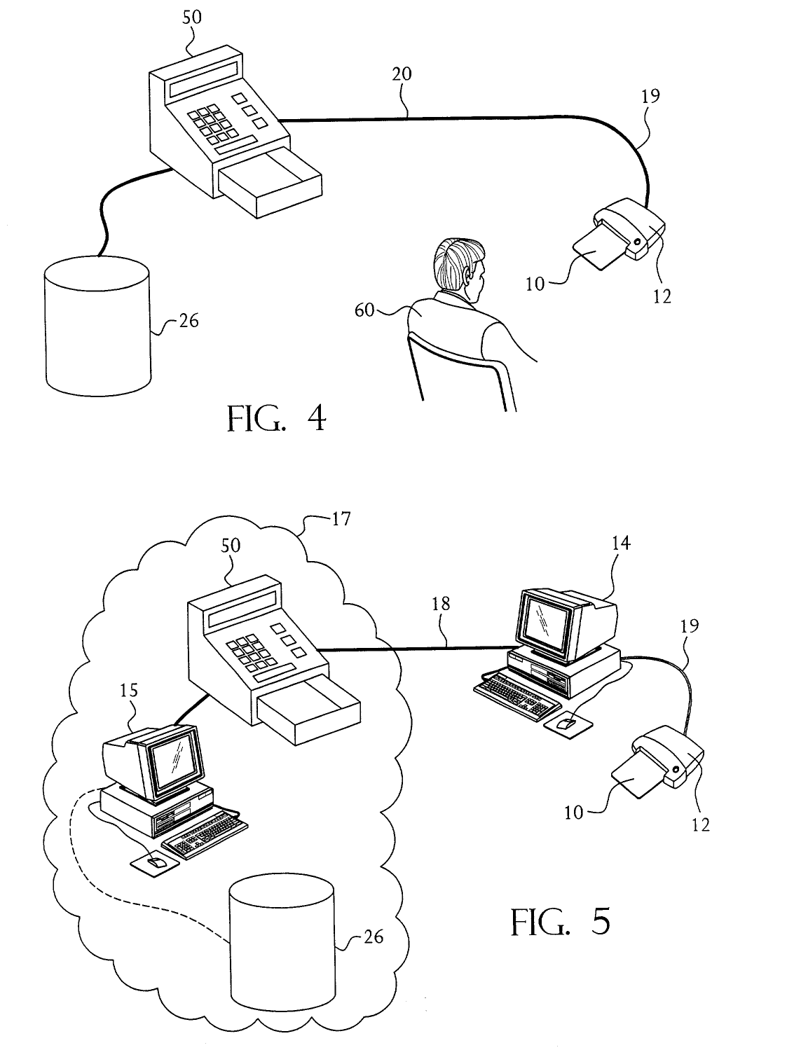

FIGS. 4 and 5 illustrate redemption of the reward at the point of purchase, whether the point of purchase is at a traditional brick and mortar retailer (FIG. 4) or an internet retailer (FIG. 5). A customer 60 redeems the reward by inserting his smart card 10 into a device 12 attached to the payment system 50. The payment system 50 redeems the reward on the smart card 10 for value, or verifies with a central database 26 that the reward should be redeemed for value. If the reward can be redeemed for value, the reward is erased from the smart card, and the value is given to the customer.

The retailer database 26 may send a reward back to the instrument 10, based on the purchases made, or about to be made at the point of sale. Those rewards would be transmitted to the device 12 from the retailer 26 for storage on the instrument 10 and future redemption by the customer 60.

FIG. 5 depicts a similar arrangement as that described, but using an internet retailer 17. The customer 60 visits the retailer's website 17 via the internet 18 using a computer 14. While the user is browsing the website, or prior to making a purchase, the consumer inserts his instrument 10 into the reader 12 which is connected to the computer 14 by means of a communication link 19. The retailer's website's computer 15 recognizes the instrument, and the data therein, and may reward the customer based on the information on the instrument 10, or may allow the user to redeem data stored on the instrument for a discount on the consumer's purchase. The retailer's website's computer may generate discounts or coupons for the customer while he is visiting the website, based on the customer's past purchasing history, or just to encourage purchases during the customer's visit to the website.

While the rewards have been shown and described mostly in terms of coupons and merchandise, other rewards are possible. For instance, the rewards could be in the form of generic “points.” Those points are redeemed for goods, access to restricted material, consumer goods, or other discounts. This way of rewarding the customer to exchange his point reward for his choice of goods or services, rather than limiting him to specific rewards.

The restricted material could be a secure Internet web page. For instance, a user with a certain number of points would be able to access a web page with stock market information unavailable to user's without the points, or an Internet game site that is otherwise restricted.

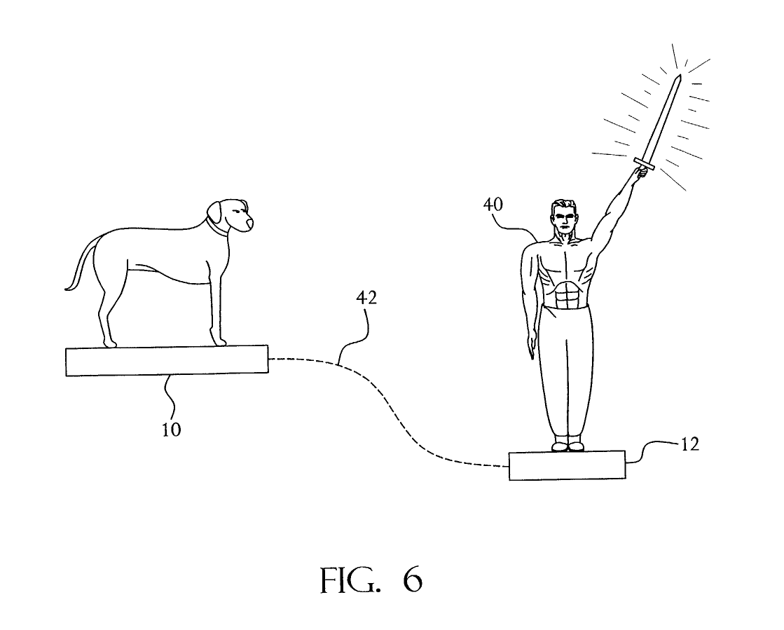

It is also contemplated that the reward could activate a consumer good as shown in FIG. 6. For the embodiment shown, the reward saved on the instrument 10 (as shown in FIG. 6, the instrument is a toy) activates a second toy 40 when they are brought into communication 42 with each other.

In practice, this may be illustrated by a movie studio seeking to promote a movie in conjunction with a fast food chain. The studio could offer promotional toys related to the movie through the fast food chain. When the toy is purchased, it is active (that is, it lights up, talks, or works in the manner it is supposed to). However, after some time length of time, or number of uses, the toy deactivates. The only way to reactivate the toy is for the customer to visit the fast food chain and secure another reward (by making another food purchase), store it on her instrument, and again activate the toy by placing the instrument 10 in communication with the device 12, which recognizes the new reward and reactivates the toy. While this has been described using a movie/toy/fast food chain model, it will be recognized that the invention is not limited to toys, movie promotions, and fast food chains.

The present invention may be embodied in still further specific forms without departing from the spirit or essential attributes thereof.

What is claimed is:

1. A method of monitoring purchasing activity of customers and rewarding customers who meet at least one preselected criterion, comprising the steps of:
a) providing a customer with an instrument capable of storing data in electronic form for later retrieval;
b) reading and updating data stored on the instrument when the customer presents the instrument at a retail location to create a record of the customer's purchasing activity history;
c) determining from the record of the customer's purchasing activity history whether the customer meets at least one preselected criterion for a reward; and
d) enabling the customer to use the instrument to obtain a reward based on the customer's purchasing activity history.

2. The method of claim 1, wherein the step of providing the customer with an instrument comprises providing the customer with a smart card capable of storing data for later retrieval.

3. The method of claim 1, wherein the step of providing the customer with an instrument comprises providing the customer with a three dimensional consumer good capable of storing data for later retrieval.

4. The method of claim 1, wherein the step of providing the customer with an instrument comprises providing the customer with a three dimensional consumer good capable of storing data for later retrieval, the consumer good capable of activating a second consumer good.

5. The method of claim 1, wherein the retail location is an internet retailer.

6. The method of claim 1, wherein the retail location is a traditional retail store.

7. The method of claim 1, wherein the reward comprises discount coupons, redeemable at a retailer location.

8. The method of claim 1, wherein the reward comprises points.

9. The method of claim 8, wherein the points may be exchanged for access to restricted material.

10. The method of claim 9, wherein the restricted material comprises an internet website.

11. The method of claim 9, wherein the restricted material comprises a multimedia program.

12. The method of claim 11, wherein the multimedia program comprises a game.

13. The method of claim 1, wherein the reward comprises a consumer good.

14. The method of claim 9, wherein the restricted material comprises a consumer good that is activated when the points are redeemed.

15. A system for rewarding a customer, the system comprising:
an instrument usable by a customer, the instrument capable of storing data in electronic form for later retrieval;
a device for reading data stored on the instrument and writing data to the instrument, the device writes data to the instrument, the data may represent the reward; and
a computer in communication with said device for determining whether to issue the reward to the customer based on preselected criteria, the computer makes the determination when a customer presents the instrument to a retailer.

16. The system of claim 15, wherein the retailer comprises an internet based retailer.

17. The system of claim 15, wherein the retail location comprises a traditional retail store.

18. The system of claim 15, wherein the instrument comprises a smart card.

19. The system of claim 15, wherein the instrument comprises a three dimensional consumer good.

20. The system of claim 15, wherein the instrument comprises a three dimensional consumer good capable of activating a second consumer good.

21. The system of claim 15, wherein the reward comprises a coupon redeemable for value at a retailer.

22. The system of claim 15, wherein the reward comprises points.

23. The system of claim 22, wherein the points are redeemable for access to restricted material.

24. The system of claim 23, wherein the restricted material is an internet website.

25. The system of claim 23, wherein the restricted material comprises a multimedia game.

26. The system of claim 22, wherein the points are redeemable for a consumer good.

27. The system of claim 15, wherein the reward comprises a consumer good.

28. The system of claim 23, wherein the restricted material comprises a consumer good that is activated when the points are redeemed.

29. A method for rewarding a user comprising the steps of:
a) issuing to a user an instrument capable of storing and transmitting instrument data;
b) reading data from and writing data to the instrument;
c) storing reward data on a central storage system, the central storage system capable of storing instrument data;
d) providing a communication link between the instrument and the central storage system, the communication link capable of exchanging instrument data between the instrument and the central storage system, the communication link capable of exchanging reward data between the instrument and the central storage system;
wherein the user can selectively redeem the instrument data for reward data, the reward data generated from the central storage system if the user has met preselected criteria.

30. The method of claim 29, wherein the reward data comprises:
retail coupon data, retail coupon data being an electronically stored retail coupon;
wherein the instrument data selectively comprises retail coupon data;
wherein retail coupon data is transmitted to the instrument from the central storage system via the communication link;
wherein the retail coupon data may be exchanged for value when the user makes a purchase at a retailer.

31. The method of claim 29 wherein the instrument data stored on the instrument may be exchanged for access to restricted material.

32. The method of claim 29 wherein the instrument data stored on the instrument comprises:
point data, point data being numerical values, the numerical values increasing based on user purchases;
wherein the point data may be exchanged for access to restricted material.

33. The method of claim 29 wherein the instrument data stored on the instrument comprises:
point data, point data being numerical values, the numerical values increasing based on user purchases;
wherein the point data may be exchanged for retail coupons.

34. The method of claim 29 wherein the instrument data stored on the instrument comprises:
point data, point data being numerical values, the numerical values increasing based on user purchases;
wherein the point data may be exchanged for retail coupons;
wherein the point data may be exchanged for access to restricted material.

35. The method of claim 29 further comprising:
providing a computer, the computer in communication with the instrument, the computer in communication with the central storage system.

36. The method of claim 29, wherein the instrument data comprises:
user consumption data, user consumption data storing information related to the spending habits of the user;
wherein the central storage system accesses the user consumption data;
wherein the reward data is made available to the user based on the user consumption data.

37. The method of claim 29, wherein the reward data is generated from the central storage system to the user based on the user's purchase history.

38. A method for storing and retrieving user data comprising the steps of:
a) providing the user with a instrument, the instrument capable of storing and transmitting instrument data;
b) providing an instrument reader/writer for reading data stored on the instrument, the instrument reader/writer also capable of writing data to the instrument;
c) providing a central storage system, the central storage system storing multimedia data, the central storage system capable of storing instrument data;
d) providing a computer, the computing device in communication with the instrument reader/writer, the computer in communication with the central storage system, the computer capable of exchanging multimedia data between the central storage system and the computing device;
e) providing a first communication link between the instrument read/writer and the central storage system, the communication link capable of exchanging instrument data between the instrument and the central storage system,
wherein the instrument data is transmitted to the central storage system through the first communication link;
wherein the instrument data allows a user access to multimedia data.

39. The method of claim 38, wherein the reward is generated from the central storage system to the user based on the user's purchase history.

40. The method of claim 38, wherein the multimedia data comprises an interactive game;
wherein the instrument data comprises interactive game data, the interactive game data allowing the user access to the interactive game.

41. The method of claim 40, wherein the interactive game data allows a user to save game data related to the interactive game on the instrument, the game data capable of being retrieved by the interactive game.

42. The method of claim 39 wherein the instrument data stored on the instrument comprises:
point data, point data being numerical values, the numerical values decreasing proportionally with the number of times a user accesses the multimedia data, when the point data is less than a threshold value, the user is not permitted to access the multimedia data.

43. The method of claim 42 wherein the point data may be increased.

44. A method for storing and retrieving user data comprising the steps of:
a) providing the user with a smart card, the smart card capable of storing and transmitting card data;
b) providing a card reader/writer for reading card data stored on the smart card, the card reader/writer also capable of writing card data to the smart card;
c) providing an internet site;
e) providing a communication link between the card read/writer and the web site, the communication link capable of exchanging card data between the smart card and the internet site;
wherein internet site selectively grants access to retail coupons.

45. A method of monitoring purchasing activity of customers and rewarding customers who meet at least one preselected criterion, consisting of the steps of:
a) providing a customer with an instrument capable of storing data in electronic form for later retrieval;
b) reading and updating data stored on the instrument when the customer presents the instrument at a retail location to create a record of the customer's purchasing activity history;
c) determining from the record of the customer's purchasing activity history whether the customer meets at least one preselected criterion for a reward; and
d) enabling the customer to use the instrument to obtain a reward based on the customer's purchasing activity history.

46. A system for rewarding a customer, the system consisting of:
an instrument usable by a customer, the instrument capable of storing data in electronic form for later retrieval;
a device for reading data stored on the instrument and writing data to the instrument, the device writes data to the instrument, the data may represent the reward; and
a computer in communication with said device for determining whether to issue the reward to the customer based on preselected criteria, the computer makes the determination when a customer presents the instrument to a retailer.
